(19) United States
(12) Patent Application Publication
(10) Pub. No.: US 2016/0318158 A1
(43) Pub. Date: Nov. 3, 2016

(54) WRENCH

(71) Applicant: Douglas L. BERGLUND, Minneapolis, MN (US)

(72) Inventor: Douglas L. BERGLUND, Minneapolis, MN (US)

(21) Appl. No.: 15/107,847

(22) PCT Filed: Dec. 23, 2013
(86) PCT No.: PCT/US2014/072153

§ 371 Date: Jun. 23, 2016

Related U.S. Application Data
(60) Provisional application No. 61/920,186, filed on Dec. 23, 2013.

(51) Int. Cl. B25B 7/02; B25B 7/14

(52) U.S. Cl. CPC B25B 7/02; B25B 7/14

(57) ABSTRACT

The wrench includes a first member having a first jaw. The first jaw has at least one first nut member contacting edge. The wrench also has a second member having a second jaw. The second jaw has at least one second nut member contacting edge. The wrench further has a pivot axis at which the first and second members are pivotably coupled to each other, thereby allowing the first and second jaws to be movable between an open position and a closed position, and at least one opening defined by the at least one first nut member contacting edge and the at least one second nut member contacting edge, when the first and second jaws are positioned in the closed positions.

### FIELD

This disclosure relates generally to a hand tool, and more particularly, but not by way of limitation, to a wrench that can be used to tighten or loosen joints.

### BACKGROUND

Wrenches are typically used for tightening or loosening nut-bolt joints because finger-hand strength is often insufficient. Wing nuts have been employed to provide convenient mechanical advantages by providing additional leverage to allow fingers to purchase on the wings. In such circumstances, a user might tighten or loosen wing nuts without utilizing a tool. However, when multiple wing nuts need to be securely and quickly tightened or loosened, and the tightening or loosening action needs to be performed repetitively, it is difficult to do so by mere finger-hand strength without over tensioning. In fact, fingers alone are often insufficient to completely and securely tighten a nut, and they are especially inadequate to loosen a securely tightened nut.

### SUMMARY

Some embodiments of a wrench for tightening or loosening a nut can be configured to have a first member having a first jaw and a first holding arm, and a second member having a second jaw and a second holding arm. The first and second members are articulated to one another by a joint. In such circumstances, the wrench can be configured to allow the user to grasp the holding arms to cause the jaws to clamp over the nut, and thereby allow the user to rotate the wrench which in turn rotates the nut for tightening or loosening. This configuration allows the nut to be accessed even in obscure angle settings, and thus allows the nut to be tightened or loosened more easily, quickly and securely. Moreover, the wrench forms an axial extension of the nuts, and as a result, the user can operate the wrench at an axially distant location. Further, the wrench disclosed herein requires a small radial space for tightening or loosening the nut. For example, when it is used to tighten or loosen a wing nut, the wrench can require a space having a radius that is substantially as small as a radius of the wing nut. The wrench can be used for tightening or loosening various sizes and types of nuts, such as butterfly nuts, castle nuts, shank nuts, cap nuts, spring nut, or the like. It is to be understood that the wrench not only can be used for tightening or loosening nuts but also can be used in other applications, such as tightening a bolt, etc.

Particular embodiments include a wrench. The wrench includes a first member having a first jaw. The first jaw has at least one first nut member contacting edge. The wrench also has a second member having a second jaw. The second jaw has at least one second nut member contacting edge. The wrench further has a pivot axis at which the first and second members are pivotably coupled to each other, thereby allowing the first and second jaws to be movable between an open position and a closed position, and at least one opening defined by the at least one first nut member contacting edge and the at least one second nut member contacting edge, when the first and second jaws are positioned in the closed positions. The at least one opening has a central axis extending through a geometric center of the at least one opening and perpendicular to a plane in which the at least one opening lies. The first and second jaws move away from the central axis when the first and second jaws are moving toward the open position, and the first and second jaws move toward the central axis when the first and second jaws are moving toward the closed position.

In some embodiments, a method of making the wrench may include fabricating first and second nut member contacting edges so that the first and second nut member contacting edges correspond to each other and define an opening.

Other embodiments may include a method of using the wrench. The method includes approaching a nut from a central axis direction of an opening; clamping the nut by first and second jaws; and rotating the nut to tighten or loosen the nut.

These and other embodiments described herein may provide one or more of the following benefits. First, some embodiments of the wrench can be configured to allow the user to grasp the holding arms to cause the jaws to clamp over the nut, and thereby allow the user to rotate the nut for tightening or loosening. This configuration allows the nut to be accessed even in obscure angle settings, and thus allows the nut to be tightened or loosened more easily, quickly and securely. Second, the wrench forms an axial extension of the nuts, and as a result, the user can operate the wrench at an axially distant location. Third, the wrench disclosed herein requires a small radial space for tightening or loosening the nut. For example, when it is used to tighten or loosen a wing nut, the wrench can require a space having a radius that is substantially as small as a radius of the wing nut. Fourth, the wrench can be used for tightening or loosening various sizes and various types of nuts, such as butterfly nuts, castle nuts, shank nuts, cap nuts, spring nut, or the like. As a result, the wrench allows maximum leveraged and secured tightness to be achieved with much less effort and little to no damage to the nut, not to mention pain to the user's hands, during a tightening or loosening procedure.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a perspective view of an embodiment of a wrench with a nut clamped between its jaws.

FIG. 2 is a perspective view of the wrench of FIG. 1.

FIG. 3 is a side view of the wrench of FIG. 1.

FIG. 4 is a further side view of the wrench of FIG. 1, with two pliers parts spreading largely in a V-shape, and holding arms disposed apart from one another.

FIG. 5 is a partial sectional view taken along line V-V in FIG. 2.

FIG. 6 is shows a surface of a first jaw, viewed in the direction of the arrow VI in FIG. 4.

FIGS. 7A-F show various shapes of the opening defined by first and second jaws when the jaws are in a closed position.

FIGS. 7G-I show multiple openings defined by the first and second jaws when the jaws are in a closed position.

FIG. 8 is a perspective view of another embodiment of the wrench.

FIG. 9 is a perspective view of a further embodiment of the wrench.

FIG. 10 is a perspective view of a still further embodiment of the wrench.

FIG. 11 is a perspective view of a yet further embodiment of the wrench.

FIG. 12A is a perspective view of another embodiment of the wrench when the first and second jaws are in a closed position with portions of the wrench being disclaimed.

FIG. 12B is a front view of the wrench of FIG. 12A.

FIG. 12C is a front view of the wrench of FIG. 12A.

FIG. 12D is a front view of the wrench of FIG. 12A.

FIG. 12E is a front view of the wrench of FIG. 12A.

Like reference symbols in the various drawings indicate like elements.

### DETAILED DESCRIPTION

Some embodiments of a wrench for tightening or loosening a nut can be configured to have a first member having a first jaw and a first holding arm, and a second member having a second jaw and a second holding arm. The first and second members are articulated to one another by a joint. In such circumstances, the wrench can be configured to allow the user to grasp the holding arms to cause the jaws to clamp over the nut, and thereby allow the user to rotate the wrench which in turn rotates the nut for tightening or loosening. This configuration allows the nut to be accessed even in obscure angle settings, and thus allows the nut to be tightened or loosened more easily, quickly and securely. Moreover, the wrench forms an axial extension of the nuts, and as a result, the user can operate the wrench at an axially distant location. Further, the wrench disclosed herein requires a small radial space for tightening or loosening the nut. For example, when it is used to tighten or loosen a wing nut, the wrench can require a space having a radius that is substantially as small as a radius of the wing nut. The wrench can be used for tightening or loosening various sizes and types of nuts, such as butterfly nuts, castle nuts, shank nuts, cap nuts, spring nut, or the like. It is to be understood that the wrench not only can be used for tightening or loosening nuts but also can be used in other applications, such as tightening a bolt, etc.

For convenience of explanation, the wrench is to be described as a wrench for tightening or loosening a wing nut. However, it is to be understood that the wrench can be used for tightening or loosening various sizes and types of nuts, such as butterfly nuts, castle nuts, shank nuts, cap nuts, spring nut, or the like. It is also to be understood that the wrench not only can be used for tightening or loosening nuts but also can be used in other applications, such as tightening a bolt, etc.

The terms “above,” “on,” “under,” “top,” “bottom,” “up,” “down,” “upper,” “lower,” “horizontal,” “vertical,” “front,” “rear,” “left,” “right” and the like used herein are in reference to the relative positions of the wrench and its constituent parts, as oriented in the specific figures being described. These terms are not meant to be limiting in any way.

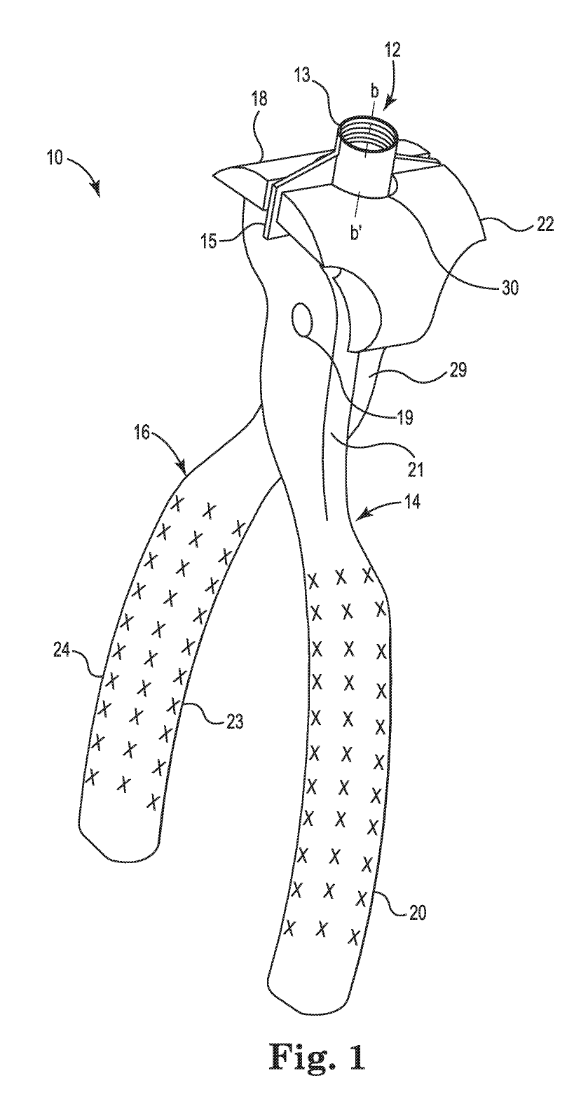

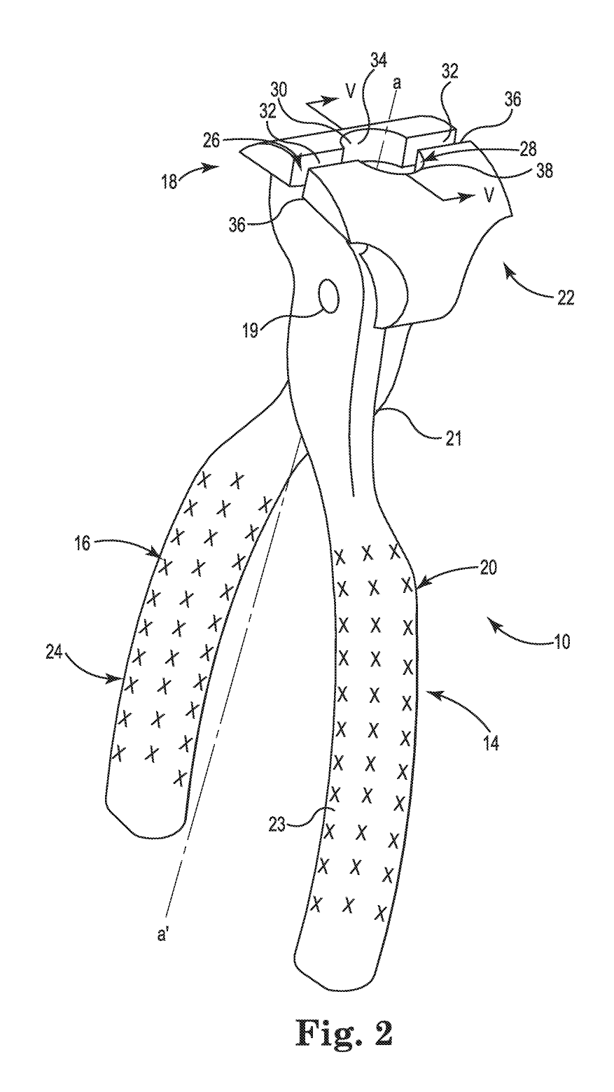

FIGS. 1 and 2 illustrate details of a wrench 10 for tightening or loosening a nut 12. The nut 12 includes a nut member 13 located at a center of the nut and a pair of radially extending wings 15. However, it is to be understood that the nut can be any types of nuts and is not limited to wing nut. Also, the nut member 13 is not necessarily located at a center location of the nut.

The wrench 10 has a first member 14 and a second member 16. The first and second members 14, 16 are articulated to one another via a coupling member at a pivot axis 19. The first member 14 has a first jaw 18, a first holding arm 20 and a first joint portion 21. The second member 16 has a second jaw 22, a second holding arm 24 and a second joint portion 29.

Referring to FIGS. 1-4, the first and second holding arms 20, 24 can be constructed to have a curved configuration for easy grasping in the palm of the user's hand. However, other shapes can be used for the first and second holding arms 20, 24. As can be seen from FIGS. 1 and 2, the first holding arm 20 is connected to the first jaw 18 by the first joint portion 21, and the second holding arm 24 is connected to the second jaw 22 by the second joint portion 29. The pivot axis 19 is arranged between the ends of the first member 14 and second member 16. The first and second members 14, 16 are shaped and disposed so as to be pivotable at the pivot axis 19 by a fastener.

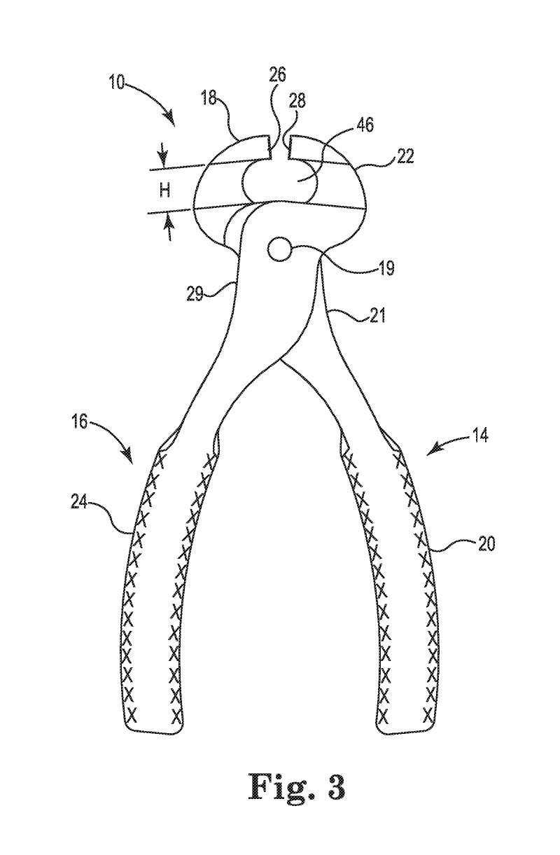

Referring to FIG. 3, the wrench 10 further includes a space 46 formed between the jaws 18, 22, and the joint portions 21, 29. The space 46 has a height H. The height H can be configured to be great enough to allow a free end of a bolt locked by the nut to extend into the space 46. When a portion of a bolt extends out of the nut 12, the space 46 receives the portion of the bolt, thereby allowing the nut 12 to be clamped between the first and second jaws 18, 22.

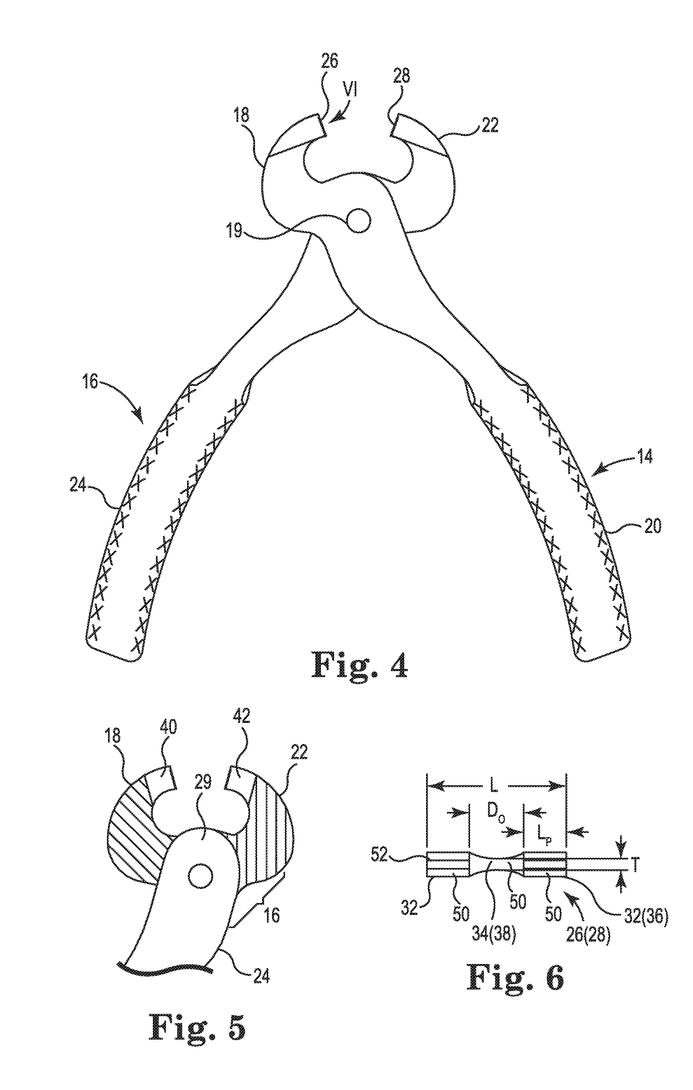

Referring to FIGS. 3-4, when closing the wrench 10, forces are exerted onto the first and second holding arms 20, 24 so that the first and second holding arms 20, 24 move toward each other. The first and second members 14, 16 are configured to be rotatable about the pivot axis 19. The relative movement towards one another by the first and second holding arms 20, 24 leads to closing the first and second jaws 18. 22.

As shown in FIG. 4, the portions of the first and second members 14, 16 located upward of the pivot axis 19 form the first and second jaws 18, 22, respectively. The first and second jaws 18, 22 are configured to rotate toward one another as the first and second holding arms 20, 24 are clamped together. The first and second jaws 18, 22 are shaped to provide a first gripping surface 26 and a second gripping surface 28, respectively. In the embodiment depicted in FIGS. 1 and 2, the first gripping surface 26 can include a first nut member contacting edge 34 in a middle section and first left and right parallel edges 32 on both sides of the first nut member contacting edge 34. The second gripping surface 28 can include a second nut member contacting edge 38 in a middle section and second left and right parallel edges 36 on both sides of the second nut member contacting edge 38.

In some embodiments, the first left and right parallel edges 32 and the second left and right parallel edges 36 are positioned generally parallel to each other when the first and second jaws 18, 22 are brought into the closed position.

The size and shape of the first and second parallel edges 32, 36 and the first and second nut member contacting edges 34, 38 are configured to allow a nut of various sizes and shapes to be clamped between the first and second jaws 18, 22. Generally, the greater the contact area between the nut 12 and the gripping surfaces 26, 28, the firmer the grip will be on the nut 12.

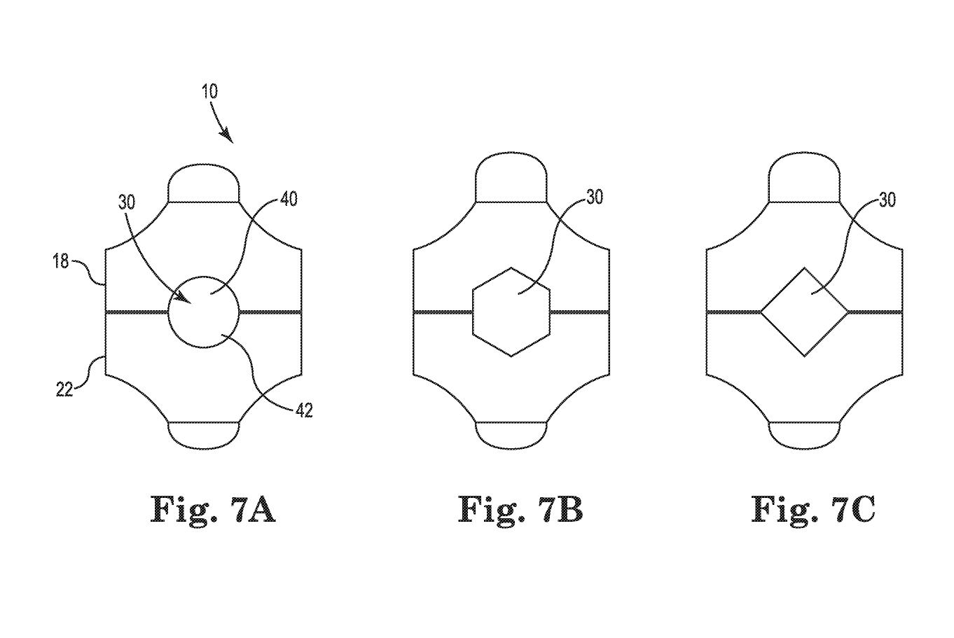

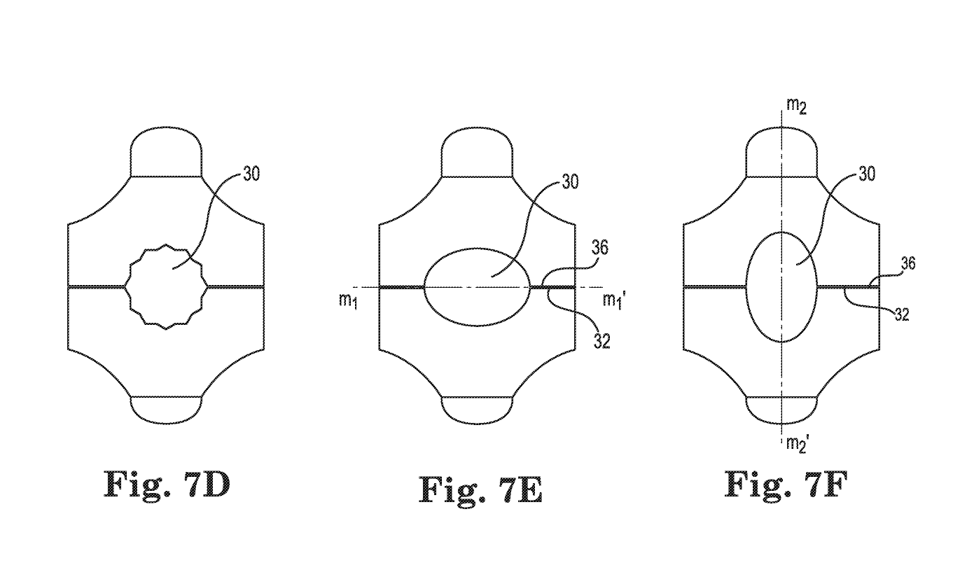

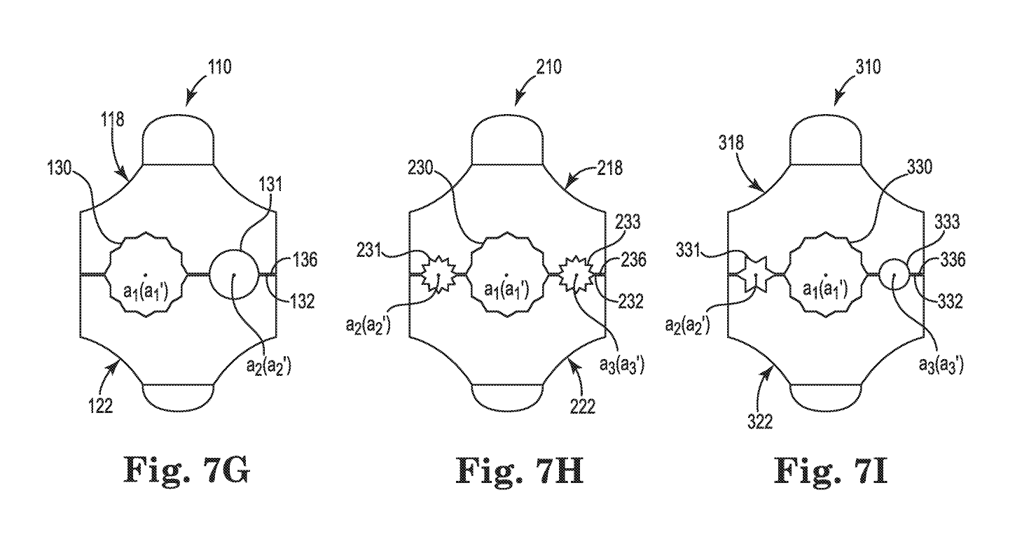

FIG. 5 is a partial sectional view of the wrench 10, running along the line V-V shown in FIG. 2. The first nut member contacting edge 34 defines a first recess 40, and the second nut member contacting edge 38 defines a second recess 42. The first and second recesses 40, 42 can be paired to form an opening 30 (referring to FIG. 7A) to receive the nut member 13 of the nut 12 when the first and second jaws 18, 22 are closed.

The first and second members 14, 16 can be produced from metal. In some embodiments, the first and second members 14, 16 can be produced by metal injection molding (MIM), also known as metal powder injection molding. In some embodiments, the first and second holding arms 20, 24 can be covered by a material that provides a particularly good grip in order to prevent slipping when handling the wrench 10. The material must be hard enough to absorb forces that occur when the wrench is used and to be able to conduct those forces to first and second jaws 18, 22.

Referring to FIG. 6, each of the first left and right parallel edges 32 and second left and right parallel edges 36 are generally rectangular in shape, each edge 32, 36 having a length Lₚ and a thickness T. In the embodiment depicted in FIG. 6, the entire length of the first or second gripping surface 26, 28 is L. In some embodiments, the entire length L of the first or second gripping surfaces 26, 28 ranges from ⅙ inch to 3 inches. It is to be understood that the size of the wrench 10 can vary depending on the size of the nut to be tightened or loosened. In some embodiments, the wrench 10 is used to clamp over a nut that has a grip of 1/10 inch or greater. In a particular embodiment, the entire length L of the first or second gripping surface 26, 28 is 1½ inch.

The thickness T of the first or second nut member contacting edge 34, 38 ranges between 0 and 2 inches. In another embodiment, the thickness T of the first or second nut member contacting edge 34, 38 ranges between ¼ inches and 2 inches. In a further embodiment, the thickness T of the first or second nut member contacting edge 34, 38 is about ¼ inches.

The thickness of the first or second left and right parallel edges 32, 36 ranges between 0 and 2 inches. In another embodiment, the thickness of the first or second left and right parallel edges 32, 36 ranges between ¼ inches and 2 inches. In a further embodiment, the thickness of the first or second left and right parallel edges 32, 36 is about ¼ inches.

In some embodiments, the wrench 10 can be configured to tighten or loosen a nut that has a diameter Dₒ ranging from 1/10 inch to 3 inches.

Still referring to FIG. 6, in some embodiments, at least one of the gripping surfaces 26, 28 respectively formed on the first and second jaws 18, 22 has a gripping enhancing feature 50 for enhancing the grip on the nut 12 during operation. In some embodiments, the gripping enhancing feature 50 can be an elastomeric, for example, silicone, deformable element disposed on at least one of the gripping surface 26, 28 respectively formed on the jaws 18, 22.

The gripping enhancing feature 50 is soft and pliable so that it can receive and clamp a full range of the side surface of the nut 12 reliably. In some embodiments, the gripping enhancing feature 50 is disposed over the entire area of the gripping surface 26 or 28 so that it can grip virtually any portion of the height of the nut 12. This allows a firm grip on the nut 12 even if the graspable portion of the nut 12 has a height that is smaller than the thickness T of the jaws 18, 22. In further embodiments, the gripping enhancing feature 50 includes surface textures 52 such as roughening, grooving, dimpling, hatching, etc. to further enhance a user's grip on the nut.

In the embodiment as depicted in FIG. 6, the surface textures 52 include three parallel grooves formed on both the first left and right parallel edges 32, and/or second left and right parallel edges 36. In other embodiments, the gripping enhancing feature 50 further includes surface textures 52 formed on the first nut member contacting edge 34 or the second nut member contacting edge 38.

Referring to FIGS. 7A-F, in some embodiments, the opening 30 can have circular shapes (referring to FIGS. 1-6 and 7A), hexagonal shapes (referring to FIG. 7B), diamond shapes (referring to FIG. 7C), 12-point shapes (referring to FIG. 7D), oval shapes (referring to FIG. 7E-F), or other shapes of openings, such as 6-point shapes. The 12-point configuration allows the wrench to be used to securely tighten or loosen a nut without wings. It is to be understood that the opening can be in other shapes as long as it is large enough to accommodate at least a portion of the nut member 13 of the nut 12.

In some embodiments, the opening 30 is configured to snuggly receive the nut member 13 of the nut 12. This helps avoid applying excessive pressure on the nut member 13, and thereby reduces the change of stripping the nut 12, and avoid damage to or destruction of the nut 12.

In some embodiments, especially when the nut 12 does not have wings 15, the opening 30 can be sized and shaped such that it generally tracks the size and shape of the outer contour of the nut member 13 of the nut 12 to assure a firm grip on the nut 12.

Referring to FIGS. 7E-F, the oval shape in this figure is a generally mathematical elliptical with its left half portion generally identical to its right half portion and with the first and second nut member contacting edges 34, 38 generally identical to each other. The embodiment depicted in FIG. 7E has a parallel elliptical opening, in which a major axis m₁-m_{1′} of the ellipse is positioned parallel to the first and second left and right parallel edges 32, 36, thereby allowing the wrench to be used to tighten or loosen multiple sizes of wing-nuts. The embodiment depicted in FIG. 7F has a perpendicular elliptical, in which the major axis m₂-m_{2′} of the ellipse is positioned generally perpendicular to the first and second left and right parallel edges 32, 36.

Referring to FIGS. 7G-I, in some embodiments, the first and second jaws define a plurality of openings. In the embodiment depicted in FIG. 7G, the wrench has a first jaw 118 and a second jaw 122. Two openings 130, 131 are defined by the first and second jaws 118, 122, and the opening 130 is larger than the opening 131. The two openings 130, 131 can have circular shapes, hexagonal shapes, diamond shapes, 12-point shapes, 6-point shapes, oval shapes, parallel elliptical shapes with a major axis generally parallel to first and second parallel edges 132, 136, perpendicular elliptical shapes with a major axis generally perpendicular to the first and second parallel edges 132, 136, other shapes of openings, or combinations thereof. In the embodiment depicted in FIG. 7G, the opening 130 has a central axis a₁-a_{1′}, and the opening 131 has a central axis a₂-a_{2′}, where the axes a₁-a_{1′} and a₂-a_{2′} are parallel to each other and lie in a same plane.

In the embodiment depicted in FIG. 7H, the wrench has a first jaw 218 and a second jaw 222. Three openings 230, 231, 233 are defined by the first and second jaws 218, 222. The opening 230 located in the middle is larger and the openings 231, 233 located on the left and right sides of the opening 230 are smaller. In the embodiment depicted in FIG. 7H, the sizes of the openings 231, 233 are generally identical to each other. However, it is to be understood, one of these two openings can be larger than the other. Also, the openings 231 or 233 on the left and right sides of the opening 230 can be larger than the opening 230.

The three openings 230, 231, 233 can have circular shapes, hexagonal shapes, diamond shapes, 12-point shapes, 6-point shapes, oval shapes, parallel elliptical shapes with a major axis generally parallel to first and second parallel edges 232, 236, perpendicular elliptical shapes with a major axis generally perpendicular to the first and second parallel edges 232, 236, other shapes of openings, or combinations thereof. In the embodiment depicted in FIG. 7H, the openings 231 and 233 have a same shape. The opening 230 has a central axis a₁-a_{1′}, the opening 231 has a central axis a₂-a_{2′}, and the opening 233 has a central axis a₃-a_{3′} where the axes a₁-a_{1′}, a₂-a_{2′} and a₃-a_{3′} are parallel to each other and lie in a same plane. In the embodiment depicted in FIG. 71, the wrench has a first jaw 318 and a second jaw 322. Three openings 330, 331, 333 are defined by the first and second jaws 318, 322. The opening 330 located in the middle is larger and the openings 331, 333 located on the left and right sides of the opening 330 are smaller. In the embodiment depicted in FIG. 71, the sizes of the openings 331, 333 are generally identical to each other. However, it is to be understood, one of these two openings can be larger than the other. Also, the openings 331 or 333 on the left and right sides of the opening 330 can be larger than the opening 330.

The three openings 330, 331, 333 can have circular shapes, hexagonal shapes, diamond shapes, 12-point shapes, 6-point shapes (referring to the opening 331), oval shapes, parallel elliptical shapes with a major axis generally parallel to first and second parallel edges 332, 336, perpendicular elliptical shapes with a major axis generally perpendicular to the first and second parallel edges 332, 336, other shapes of openings, or combinations thereof. In the embodiment depicted in FIG. 71, the openings 331 and 333 have different shapes. The opening 330 has a central axis a₁-a_{1′}, the opening 331 has a central axis a₂-a_{2′}, and the opening 333 has a central axis a₃-a_{3′} where the axes a₁-a_{1′}, a₂-a_{2′} and a₃-a_{3′} are parallel to each other and lie in a same plane.

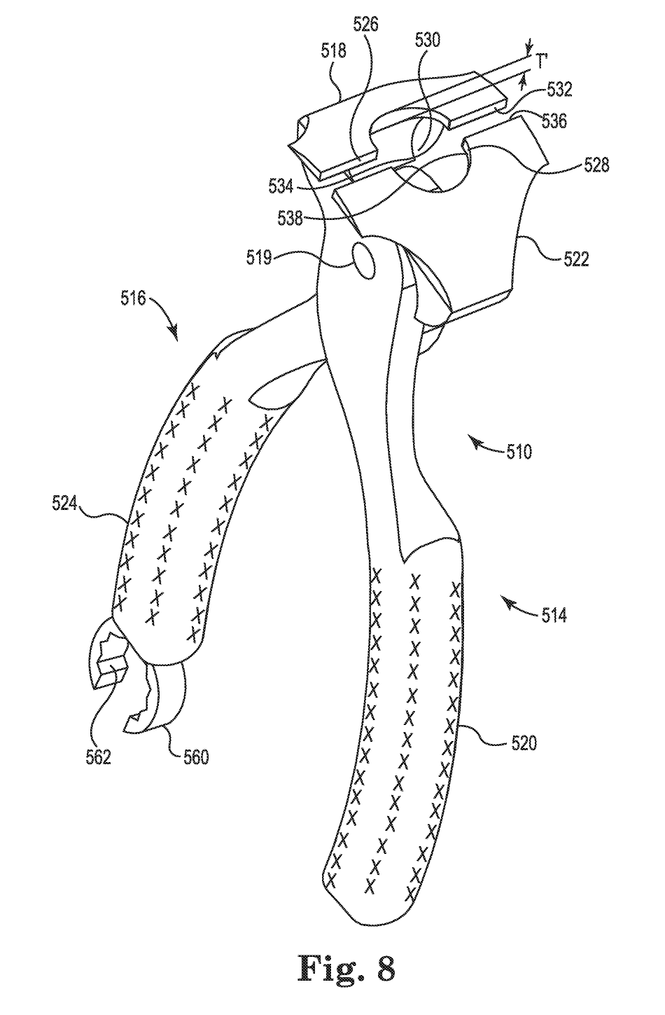

FIG. 8 illustrates the configuration of another wrench 510. The wrench 510 has a first member 514 and a second member 516. The first and second members 514, 516 are articulated one another via a coupling member at a pivot axis 519. The first member 514 has a first jaw 518 and a first holding arm 520. The second member 516 has a second jaw 522 and a second holding arm 524. As shown in FIG. 8, a thickness T′ of a first or second gripping surface 526, 528 respectively formed on the first and second jaws 518, 522 can be smaller than the thickness T of the first or second gripping surface 26, 28 in the previous embodiment as shown in FIGS. 1-6. In some embodiments, the thickness T′ of the first or second nut member contacting edge 534, 538 can range between 0 and 1/15 inches. In another embodiment, the thickness T′ of the first or second nut member contacting edge 534, 538 can be 1/15 inches.

In some embodiments, the thickness of the first or second left and right parallel edges 532, 536 can range between 0 and 1/15 inches. In another embodiment, the thickness of the first or second right parallel edges 532, 536 can be 1/15 inches.

In the embodiment illustrated in FIG. 8, the thickness T′ of each of the nut member contacting edges 534, 538 decreases from a central portion of the nut member contacting edge 534, 538 toward the respective left and right parallel edges 532, 536. This is different from the previous embodiment as shown in FIGS. 1-6, in which the thickness T of each of the nut member contacting edges 34, 38 increases from a central portion of the nut member contacting edge 34, 38 toward the respective left and right parallel edges 32, 36.

Optionally, the wrench 510 can further include an auxiliary wrench 560 for tightening or loosening nuts. In the depicted embodiment, the auxiliary wrench 560 is a semi-closed wrench having a polygonal inner periphery 562.

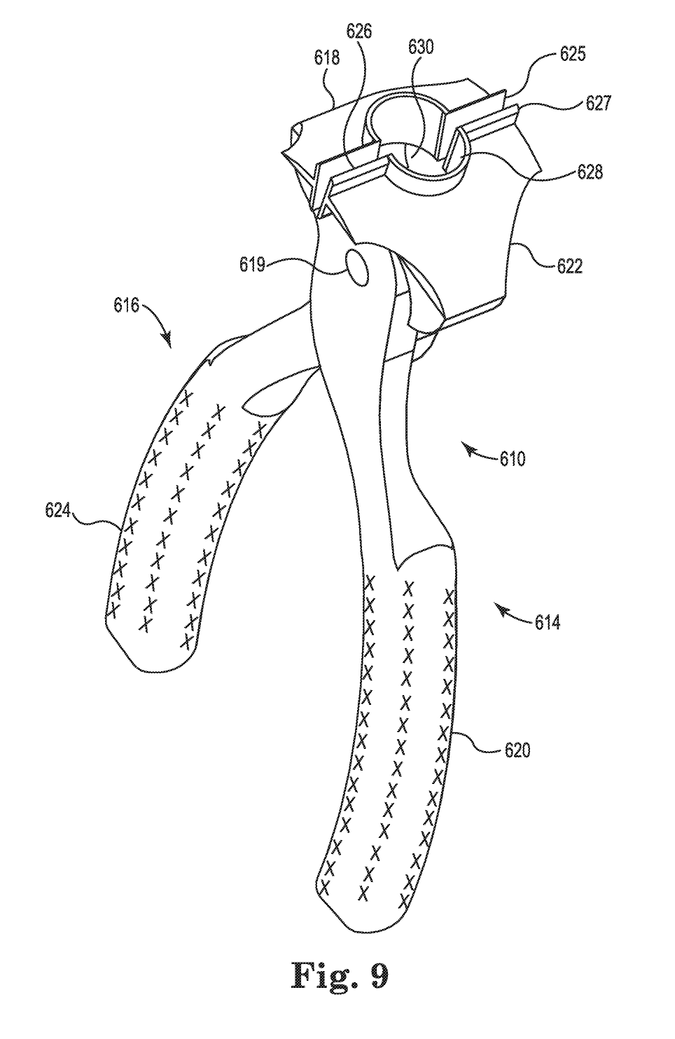

FIG. 9 illustrates the configuration of yet another wrench 610. The wrench 610 has a first member 614 and a second member 616. The first and second members 614, 616 are articulated one another via a coupling member at a pivot axis 619. The first member 614 has a first jaw 618 and a first holding arm 620. The second member 616 has a second jaw 622 and a second holding arm 624. As shown in FIG. 9, the first jaw 618 includes a first flange 625, and the second jaw 622 includes a second flange 627. The flanges 625, 627 help form enlarged gripping surfaces 626, 628, and thus allow a firmer grip on the nut.

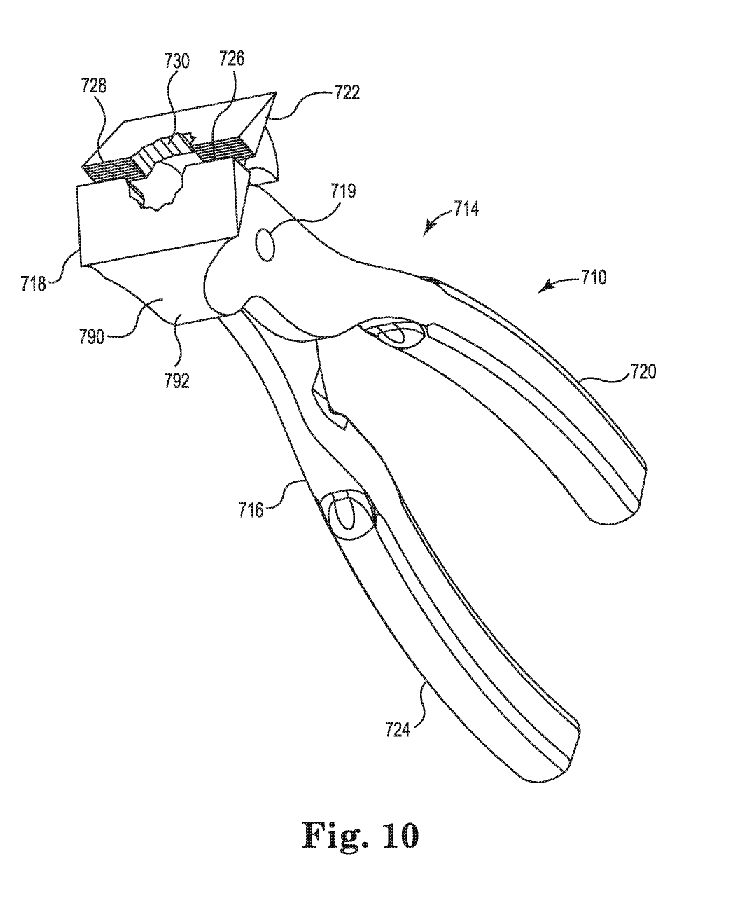

FIG. 10 illustrates the configuration of yet another wrench 710. The wrench 710 has a first member 714 and a second member 716. The first and second members 714, 716 are articulated one another via a coupling member at a pivot axis 719. The first member 714 has a first jaw 718 and a first holding arm 720. The second member 716 has a second jaw 722 and a second holding arm 724. As shown in FIG. 10, each of the first and second jaws 718, 722 includes a stepped portion 790 formed on a side 792 of the respective jaw 718, 722 opposite the respective gripping surface 726 or 728. In addition, the first and second holding arms 720, 724 are formed with edges for easy fabricating. The wrench 710 further includes an opening 730 which has a plurality of notches, for example, 12 notches. This allows the wrench 710 to be used to securely tighten or loosen a nut without wings.

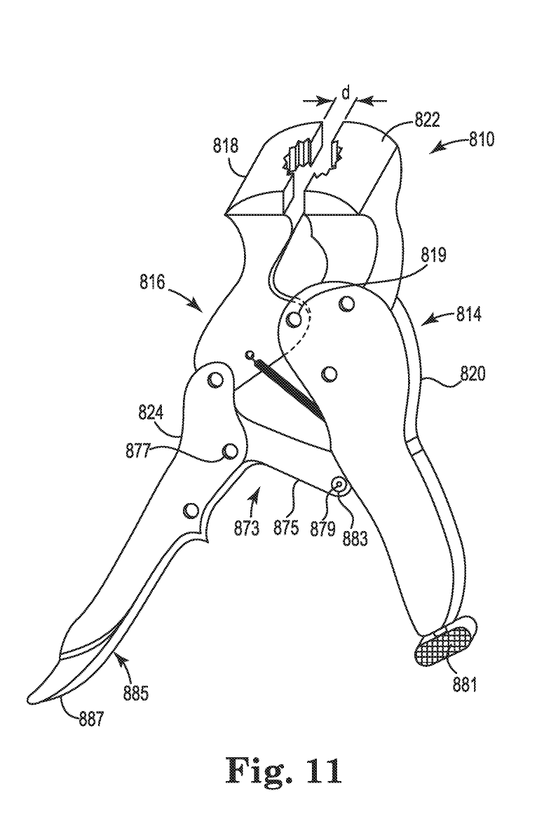

FIG. 11 illustrates the configuration of yet another wrench 810. The wrench 810 has a first member 814 and a second member 816. The first and second members 814, 816 are articulated one another via a coupling member at a pivot axis 819. The first member 814 has a first jaw 818 and a first holding arm 820. The second member 816 has a second jaw 822 and a second holding arm 824. As shown in FIG. 11, the wrench 810 has a locking mechanism 873 for locking the wrench 810. It is to be understood that the locking mechanism 873 can take various form. In the embodiment depicted in FIG. 11, when the first and second jaws 818, 822 approach each other until a desired jaw distance d is reached between the first and second jaws 818, 822, or until the first and second jaws 818, 822 purchase on a side surface of the nut 12 and clamp over the nut 12 with desired forces, the locking mechanism 873 can be used to lock the wrench 810. In such circumstances, the first and second jaws 818, 822 are prevented from moving relative to each other and the jaw distance remains constant, even after a plurality of engagements and disengagements of the wrench 810 with the nut 12. The jaw distance will not be changed until the wrench is unlocked.

The locking mechanism 873 includes a link 875 that is pivotably connected between the first and second holding arms 820, 824 to lock the arms and the first and second jaws 818, 822 relative to one another. One end of the link 875 is pivotably connected to the second holding arm 824 at pivot 877. The opposite end of link 875 is pivotably connected to a collar 883 by pivot pin 879. The collar 883 is threadably mounted on a screw 881. The screw 881 is located in the first holding arm 820 such that the longitudinal axis of the screw 881 is disposed along and located in the first holding arm 820. Rotation of the screw 881 moves the collar 883 along the length of the screw 881, i.e., the screw 881 is rotated, the collar 883 is moved in a straight line up and down the length of the screw 881 and the first holding arm 820. The locking mechanism 873 also includes a release lever 885. The release lever 885 is pivotably connected to the second holding arm 824 such that a user may depress the end 887 of lever 885 to move the link 875, thereby unlocking the locking mechanism 873.

The collar 883 moves up and down the length of the first holding arm 820, and as a result the effective length of the locking mechanism is changed to vary the spacing between the first and second jaws 818, 822 in the clamped or locked position. Rotation of adjusting screw 881 changes the distance between pivot 879 and the pivot axis 819. By varying this distance the space between the first and second jaws 818, 822 and the clamping force exerted by the jaws 818, 822 on the nut 12 may be varied and the jaws 818, 822 may be adjusted to grip the nut 12 of varying size with varying force.

It is to be understood that other types of locking mechanism can be used to lock the first and second jaws 818, 822 so that they are not movable relative to each other.

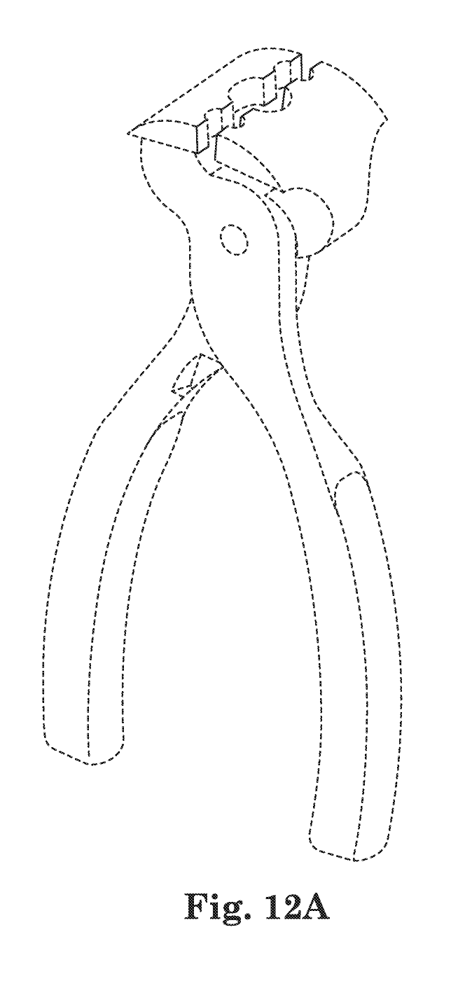

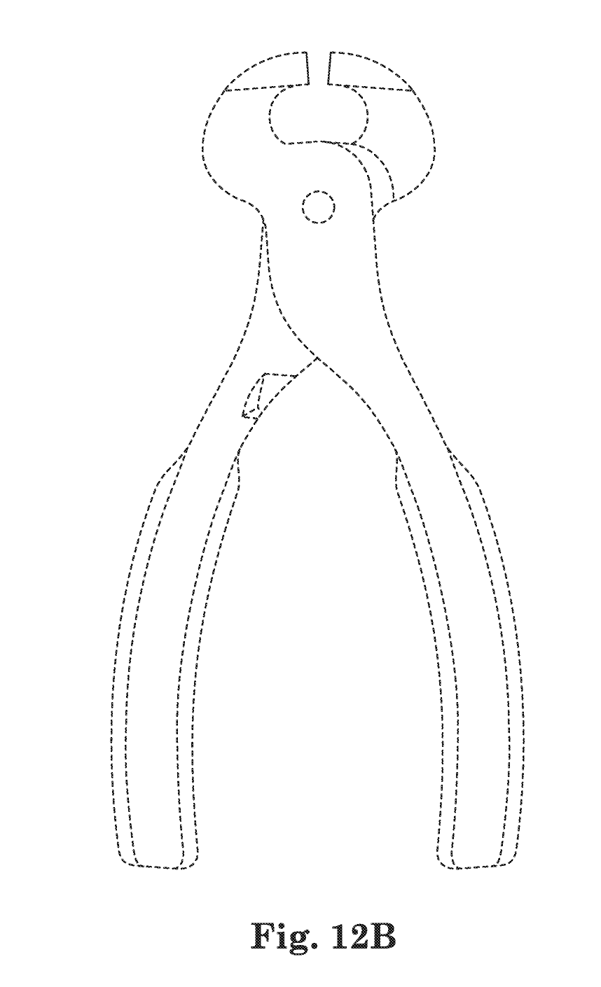

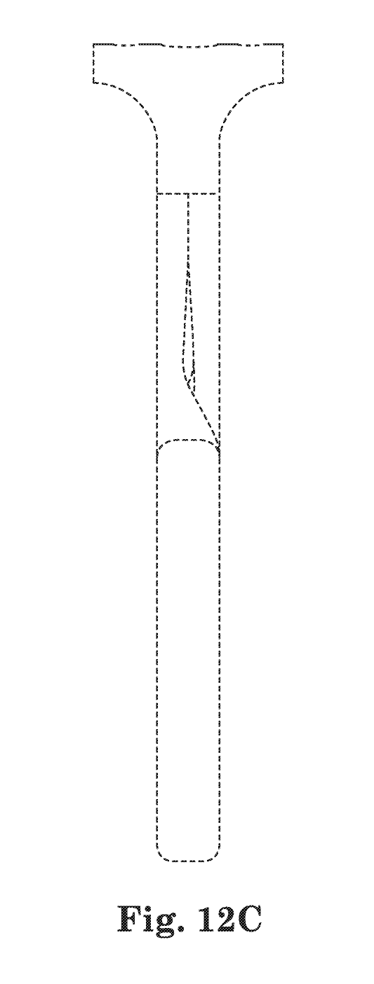

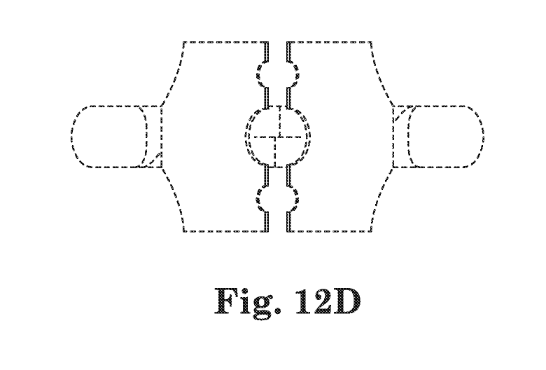

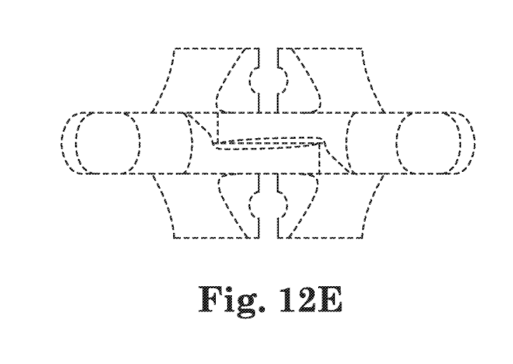

Referring to FIGS. 12A-E, a further embodiment of the wrench is illustrated with portions of the wrench being disclaimed. In this further embodiment, the jaws of the wrench define three openings, including a disclaimed larger opening in the middle, and two disclaimed smaller openings on the left and right sides of the larger opening.

A number of embodiments of the invention have been described. Nevertheless, it will be understood that various modifications may be made without departing from the spirit and scope of the invention.

1. A wrench, comprising
a first member having a first jaw, the first jaw having at least one first nut member contacting edge;
a second member having a second jaw, the second jaw having at least one second nut member contacting edge;
a pivot axis at which the first and second members are pivotably coupled to each other, thereby allowing the first and second jaws to be movable between an open position and a closed position;
at least one opening defined by the at least one first nut member contacting edge and the at least one second nut member contacting edge, when the first and second jaws are positioned in the closed positions, the at least one opening having a central axis extending through a geometric center of the at least one opening and perpendicular to a plane in which the at least one opening lies,
wherein the first and second jaws move away from the central axis when the first and second jaws are moving toward the open position, and the first and second jaws move toward the central axis when the first and second jaws are moving toward the closed position.

2. The wrench of claim 1, wherein
the first jaw has a plurality of first nut member contacting edges, and the second jaw has a plurality of second nut member contacting edges,
each of the plurality of the first nut member contacting edges corresponding to one of the plurality of the second nut member contacting edges,
a plurality of openings defined by the plurality of first nut member contacting edges and the corresponding plurality of second nut member contacting edges, when the first and second jaws are positioned in the closed positions,
each of the openings have a central axis extending through a geometric center of the respective opening and perpendicular to a plane in which the respective opening lies,
the first and second jaws move away from the central axes of the plurality of openings when the first and second jaws are moving toward the open position, and the first and second jaws move toward the central axes of the one or more openings when the first and second jaws are moving toward the closed position.

3. The wrench of claim 2, wherein the central axes of the plurality of openings lie in a same plane.

4. The wrench of claim 2, wherein the central axes of the plurality of openings are parallel to each other.

5. The wrench of claim 2, wherein the pivot axis and the central axes of the plurality of openings lie in a same plane.

6. The wrench of claim 2, wherein the shapes of the plurality of openings are selected from the group consisting of circular shapes, oval shapes, parallel elliptical shapes with a major axis generally parallel to the first and second parallel edges, perpendicular elliptical shapes with a major axis generally perpendicular to the first and second parallel edges, diamond shapes, hexagonal shapes, 12-point shapes and 6-point shapes or combination thereof.

7. The wrench of claim 2, wherein the plurality of openings have different sizes.

8. The wrench of claim 1, wherein the pivot axis and the central axis lie in a same plane.

9. The wrench of claim 1, wherein a thickness of the first nut member contacting edge and a thickness of the second nut member contacting edge range between 0 and 2 inches.

10. The wrench of claim 1, wherein the first and second jaws have a generally identical shape and a generally identical size.

11. The wrench of claim 1, further comprising a locking mechanism that locks the wrench when the first and second jaw purchase on and press a side surface of the nut.

12. The wrench of claim 1, wherein the first jaw further has a first parallel edge extending from an end of the first nut member contacting edge away from the central axis when the first and second jaws are in the closed position, and the second jaw further has a second parallel edge extending from an end of the second nut member contacting edge away from the central axis when the first and second jaws are in the closed position, the first and second parallel edges being positioned facing directly toward each and parallel to each other when the first and second jaws are in the closed position.

13. The wrench of claim 12, wherein when the first and second jaws move between the open and closed positions, a moving direction is generally perpendicular to the first and second parallel edges.

14. The wrench of claim 12, wherein a thickness of the first nut member contacting edge is greater than a thickness of the first parallel edge, and thickness of the second nut member contacting edge is greater than a thickness of the second parallel edge.

15. The wrench of claim 12, wherein at least one of the first and second nut member contacting edges includes a flange enlarging the first and second nut member contacting edges in a direction parallel to the central axis.

16. The wrench of claim 12, wherein at least one of the first and second parallel edges includes a flange enlarging the first and second parallel edges in a direction parallel to the central axis.

17. The wrench of claim 12, wherein the shape of the at least one opening is selected from the group consisting of circular shapes, oval shapes, parallel elliptical shapes with a major axis generally parallel to the first and second parallel edges, perpendicular elliptical shapes with a major axis generally perpendicular to the first and second parallel edges, diamond shapes, hexagonal shapes, 12-point shapes and 6-point shapes.

18. A method of making the wrench of claim 1, comprising:
fabricating the first and second nut member contacting edges so that the first and second nut member contacting edges correspond to each other and define the opening.

19. A method of using the wrench of claim 1, comprising:
approaching the nut from the central axis direction of the opening;
clamping the nut by the first and second jaws; and
rotating the nut to tighten or loosen the nut.

20. The method claim 19, further comprising:
applying a first force to a nut by the first jaw; and
applying a second force to a nut by the second jaw,
wherein the first force and the second force are generally equal to each other.
